(19) United States
(12) Patent Application Publication
(10) Pub. No.: US 2001/0052541 A1
(43) Pub. Date: Dec. 20, 2001

(54) Powerless electronic signature apparatus based on fingerprint recognition

(76) Inventors: Hyung-Ja Kang, Seoul (KR); Myoung Je Kal, Seoul (KR); Hong-Seong Park, Seoul (KR); Young-Chul Shim, Seoul (KR)

Correspondence Address: Robert E. Bushnell, 1522 K Street, N.W., Suite 300, Washington, DC, 20005-1202, US

(21) Appl. No.: 09/774,659

(22) Filed: Feb. 1, 2001

(30) Foreign Application Priority Data
Feb. 7, 2000 (KR) 2000-5587

(51) Int. Cl. G06F 17/60

(52) U.S. Cl. 235/379

(57) ABSTRACT

Disclosed is a powerless electronic signature apparatus based on a fingerprint recognition comprises: an external communication part having an electrical connection terminal for receiving an external power and a communicative connection terminal for providing an electronic signature service means with the electronic signature creating key; a fingerprint scanner for scanning a fingerprint of a signer to create a recognition finger code; a fingerprint recognizing part for comparing the created recognition fingerprint code with a reference fingerprint code and allowing for an access to the electronic signature creating key; and an electronic signature control part for controlling the fingerprint scanner to create a recognition fingerprint code when a power is applied from the external communication part and controlling the nonvolatile memory to provide the electronic signature service means with the electronic signature creating key through the external communication part.

### CLAIM OF PRIORITY

This application makes reference to, incorporates the same herein, and claims all rights accruing thereto under 35 U.S.C. 119 through our patent application entitled Powerless Electronic Signature Apparatus Based On Fingerprint Recognition earlier filed in the Korean Industrial Property Office on Feb. 7, 2000 and there duly assigned Serial No. 2000/5587.

### BACKGROUND OF THE INVENTION

1. Field of the Invention

The present invention relates to a powerless electronic signature apparatus based on recognition of fingerprint, and more particularly, to a powerless electronic signature apparatus based on recognition of fingerprint in which a scanned fingerprint code is used as a personal identification number (PIN) in an electronic signature system.

2. Background Art

Recently, a remote banking service such as home trading (cyber stock exchange), electronic commercial business, phone banking, personal computer banking, etc., shows high preference among various financial services due to the convenience in that it is free from time and space restraints which are still in existence between financial companies and clients of them. Keeping face with such the preference, the remote banking service are gaining the popularity.

In these days, due to the development in various electronic technologies, there are widely spread a tool enabling a user to access a specific information standing in need of a security through various paths and thereby such access tools are in public. As a result, a release tool against the security is being developed even by non-experts as well as persons skilled in the art. To this end, there is being anticipated an appearance of high security technologies for blocking actions of access, opening, destroy, copy, theft, etc., by not-approved persons.

Keeping pace with these technological trends, there are various endeavors for securing the security in relation to the authentication of the remote banking service system occupying one field of a main stream.

An electronic signature system is being developed as one kind of solution for complying with these technological request.

Electronic signature specifies an author of an electronic document and confirms after the fact that a content read on a document is right and it is defined as a symbol or a code contained in an electronic document for the purpose of discriminating a signer from others and preventing an alteration by others.

Thus, since exchange of electronic documents or electronic commercial business through information communication network is performed using a network and a computer without direct contacting between the parties concerned, it is required to use the electronic signature for the confirmation of the sender in order to prevent an forgery of the sender or an alteration of a document content.

Electronic signature has advantages in that it is difficult to forge the signature since a person not having an electronic signature creation key can not sign on the electronic document, it is possible to prove that an electronic signer is the person oneself, it is difficult to arbitrarily alter the content of an electronic document containing the electronic signature, and there is no denying that the electronic document containing the electronic signature is against one's intension, in other words, there is a blocking effect of a denial. This is not only the confirmation of an party concerned and the confirmation after the fact but the guarantee on a fact that an electronic document containing such an electronic signature is not altered and has a particular function in addition to the signature. Therefore, to activate the electronic document and the electronic commercial business, there is requested a need of reliable authentication organization issuing the electronic signature, and a system which enables the electronic signature to have a legal effect.

Taking advantage of these social and technical requests, various electronic signature methods are disclosed. Examples of such the disclosures are shown in Korean Patent laid open No. 1999/78671 entitled Banking System of Fingerprint Proof Type, Korean Patent laid open No. 1999/70628 entitled Method For Distributing Key For Imaginary Banking Service of Gateway Manner, Method for Writing In Cipher and Electronic Signature Method, Korean Patent laid open No. 1996/42410 entitled Method for Authentication Exchange and Electronic Signature Methods Of Restoration Type and Additional Type, Korean Patent laid open No. 1994/22298 entitled Method for Creating and Confirming Electronic Signature and Korean Patent laid open No. 1994/2699 entitled Electronic Signature and Authentication Method.

In these electronic signature systems, an electronic signature is performed using an electronic signature creating key for the purpose of discrimination of a signer and prevention of alteration.

In order to access the electronic signature creating key established in the electronic signing apparatus, it is requested to input a personal identification number (PIN) as a confirmation means for confirming truth and false of a signer. Conventionally, this PIN is input through a key pad or keyboard by a signer.

However, when the PIN is input through the key pad or keyboard, it is exposed to a danger of a using by stealth, tapping, or unwilling disclosure of a electronic signature creating key in which an owner of the PIN is absolutely responsible for such the disclosure. Especially, when a portable type of electronic signature creating key is used, since there is still exist a possibility of loss, these dangers are highly enhanced.

To solve these problems, there is disclosed a method for determining truth or false of a signer using a biorecognition technique. Especially, a fingerprint recognition technique is highlighted as an alternative plan due to its simplicity and superior discriminating capability.

There are disclosed examples of security techniques based on the fingerprint recognition in Korean Patent laid open No. 1999/78671 entitled Banking System of Fingerprint Proof Type, Korean Patent laid open No. 1998/42759 entitled IC card and Private Data Discriminating System Operated with Same, Korean Patent laid open No. 1998/04164 entitled Security System for Use of Credit Card Using Fingerprint Recognition Technique, Korean Patent laid open No. 1997/66973 entitled Security System Using Rotation of Fingerprint and Frequency Card, Korean Patent laid open No. 1997/17037 entitled Fingerprint Recognition Security Method, Korean Patent laid open No. 1997/02757 entitled Security Apparatus For Cash Dispenser And Method For Controlling The Same, Korean Patent laid open No. 1995/23825 entitled Security System For Lending Cashbox and Korean Patent laid open No. 1999/34789 entitled Computer Security System Using Fingerprint Recognition Apparatus.

Generally, fingerprint recognition is known as a superior biorecognition technique which provides a high discriminating level of 1012. However, conventional arts have a common drawback in that a power for operating the apparatus is indispensably required to apply this fingerprint recognition technique to the security apparatus. Especially, it is general to reflect a design intention for minimizing disassembly and repair of the apparatus on developing a portable electronic signing apparatus. To this end, a life of a battery established in the apparatus directly affects on a life of the apparatus. Also, having a battery built-in acts as a factor increasing a volume of the apparatus as well as the fabrication cost of the apparatus product.

### SUMMARY OF THE INVENTION

Therefore, it is an object of the present invention to confirm truth or false of an electronic signer by comparing an input user's fingerprint code with a reference fingerprint code using an external power.

It is another object of the invention to use a scanned personal fingerprint code as a personal identification number (PIN) by deciding whether to allow an owner of an electronic signing key to access to an electronic signature creating key.

To achieve these and other objects, there is provided a powerless electronic signature apparatus based on a fingerprint recognition comprising: a nonvolatile memory for storing an electronic signature creating key for an electronic signature and a personal identification number; an external communication part having an electrical connection terminal for receiving an external power and a communicative connection terminal for providing an electronic signature service means with the electronic signature creating key; a fingerprint scanner for scanning a fingerprint of a signer to create a recognition finger code; a fingerprint recognizing part for comparing the created recognition fingerprint code with a reference fingerprint code and allowing for an access to the electronic signature creating key; and an electronic signature control part for controlling the fingerprint scanner to create a recognition fingerprint code when a power is applied from the external communication part and controlling the nonvolatile memory to provide the electronic signature service means with the electronic signature creating key through the external communication part.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of a powerless electronic signature apparatus based on recognition of fingerprint in accordance with one embodiment of the present invention;

FIG. 2 is a perspective view showing an appearance of a powerless electronic signature apparatus adapting a USB communication port as an external communication part; and

FIG. 3 is a rear perspective view of a communication terminal to which the powerless electronic signature apparatus is coupled through a USB communication port.

### DETAILED DESCRIPTION OF THE PREFERRED EMBODIMENTS

Hereinafter, preferred embodiments of a powerless electronic signature apparatus based on recognition of fingerprint are described with reference to the accompanying drawings.

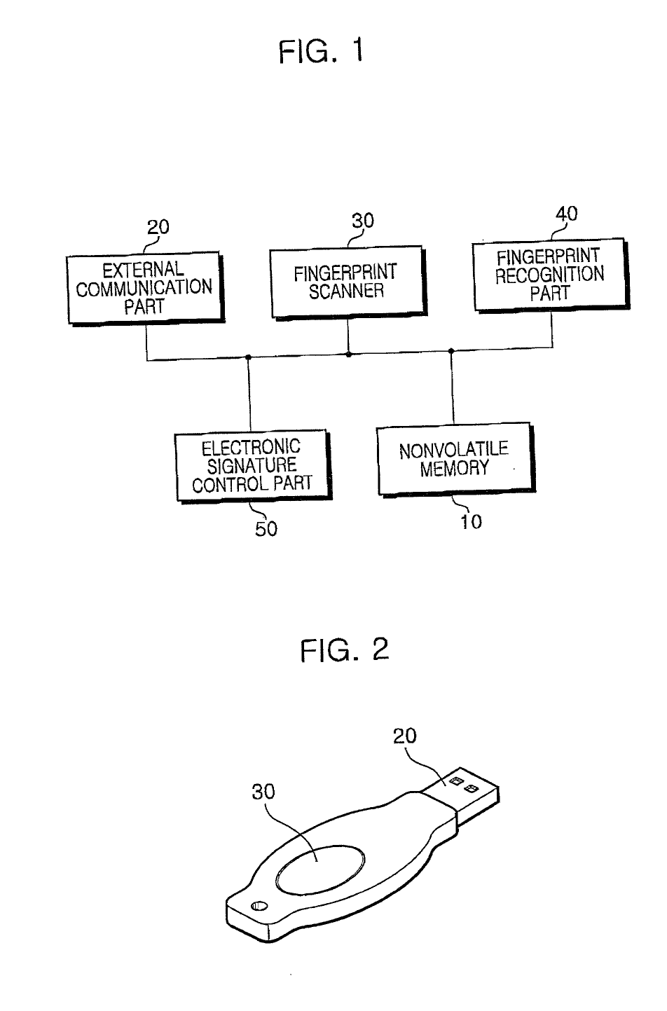

FIG. 1 is a block diagram of a powerless electronic signature apparatus based on recognition of fingerprint in accordance with one embodiment of the present invention.

Referring to FIG. 1, a powerless electronic signature apparatus based on a fingerprint recognition comprises: a nonvolatile memory 10 for storing an electronic signature creating key for an electronic signature and a personal identification number (PIN); an external communication part 20 having an electrical connection terminal for receiving an external power and a communicative connection terminal for providing an electronic signature service means with the electronic signature creating key; a fingerprint scanner 30 for scanning a fingerprint of a signer to create a recognition finger code; a fingerprint recognizing part 40 for comparing the created recognition fingerprint code with a reference fingerprint code and allowing for an access to the electronic signature creating key; and an electronic signature control part 50 for controlling the fingerprint scanner 30 to create a recognition fingerprint code when a power is applied from the external communication part 20 and controlling the nonvolatile memory 10 to provide the electronic signature service means with the electronic signature creating key through the external communication part 20.

To avoid a confusion between terms used in this application, a personal secret key indicates a secret key which is used in symmetric cryptogram system of so-called cryptosystem, and an electronic signature creating key and an electronic signature verification key indicate a private key and a public key, respectively in asymmetric cryptogram system.

An operation of the above constituted powerless electronic signature apparatus is described with reference to the accompanying drawings.

First, the nonvolatile memory 10 stores an electronic signature creating key and a reference fingerprint code for a personal identification number (PIN). The nonvolatile memory 10 is preferably selected from a group consisting of a flash memory, an erasable read only memory (EPROM) and an electrically erasable read only memory (EEPRM).

The external communication part 20 comprises an electrical connection for being supplied an external power and a communicative connection for providing an electronic signature service means with the electronic signature creating key. The external communication part 20 is selected from a group consisting of an USB (Universal serial bus) communication port, RS-232C serial communication port and a centronic parallel communication port. Especially, it is desirous to use the USB communication port, which is widely used as a communication port of a personal computer and has a Plug & Play function.

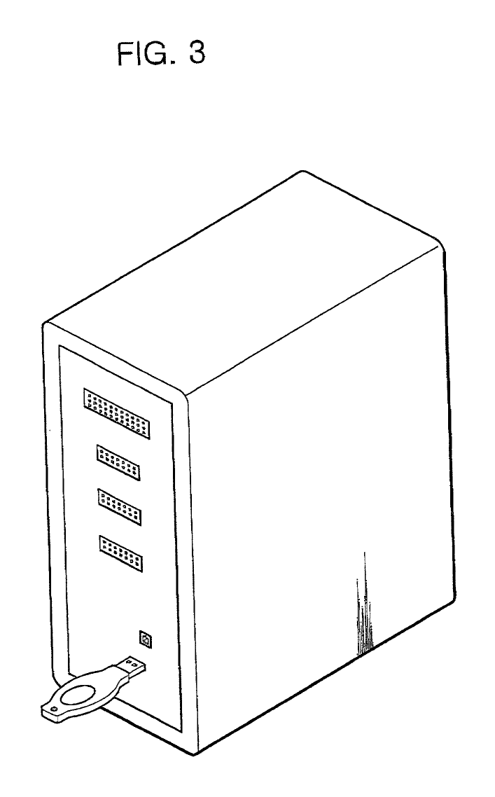

FIG. 2 is a perspective view showing an appearance of a powerless electronic signature apparatus using USB communication port 20 as the external communication part and FIG. 3 is a rear perspective view of a communication terminal to which the powerless electronic signature apparatus is coupled through the USB communication port 20.

USB communication port is a standard of a port regulation among standards of peripheral devices of personal computer made by consultation of seven companies of Intel Inc., COMPAQ Corp., IBM Inc., DEC Corp., Microsoft Inc., NEC Inc., and Northen Telecom Inc. Intel Inc., developed a controller named as “Intel 82930A” in commerce on February 1996. The controller allows the USB communication port to be applicable to the personal computer. Keeping pace with the development of the controller of Intel, PC makers in all of the world concentrate their efforts and costs on developing a product to which the controller of the Intel is applied. An operational way of the controller is evaluated as a regulation capable of completely accomplishing Plug & Play function.

RS-232 is a regulation for connecting terminal equipments such as a data terminal, a modem and a data feeder to each other. RS-232 is also a recommendation standard of the Electronic Industries Association (EIA) which is a union of enterprises in the field of American electronic industries. And, RS-232 is being used as a standard interface for intercommunication of control signal or data between a central processing unit and a peripheral unit.

As an external power is applied to the fingerprint scanner 30 from the external communication part 20, the fingerprint scanner 30 scans a fingerprint of a signer and creates a recognition fingerprint code. There are various kinds of fingerprint scanner, such as, optical type, supersonic wave type, Piezo type etc. These types of products are being developing and are selling. Especially, in these days, various fingerprint recognition chips are being developed and they are provided with the fingerprint scanner capable of being inserted into a USB communication port occupying very small volume. However, the present invention is not limited to the aforementioned fingerprint scanner and can be accomplished using any of fingerprint scanners disclosed in public at the present.

The fingerprint recognition part 40 compares the created recognition fingerprint code with the reference fingerprint code and allows for an access to the electronic signature creating key depending on the comparing result.

Conventionally, the fingerprint recognition security system reads a user's fingerprint through an electronic way, compares the read user's fingerprint with the previously input fingerprint data, and determines truth or false of the user depending on the comparing result.

Fingerprint recognition system is the oldest means of recognizing a biological body and uses a method of measuring a position and a distance of curved line and branched point in a fingerprint having different pattern every person. The fingerprint recognition system is mainly used in a criminal investigating associate when number of a user is small. While when number of a user is many, 1 to 1 system, i.e., verification mode is used in the entrance control system.

The fingerprint recognition system has a basic structure comprising an input part for photographing a fingerprint of a user and a verification part for verifying truth or false of the user by comparing the input fingerprint with the fingerprint data stored in the fingerprint database. The fingerprint recognition system uses an algorithm for extracting, storing and comparing a position and a property of a characteristic point including a branched point, an end point, a cut point, etc., of a fingerprint protrusion. However, since this fingerprint recognition system recognizes a user only using four or five characteristic points, it is incomplete. The fingerprint recognition system shows a high error occurrence rate when sweat or moisture is in contact with the scanner. Also, it has drawbacks in that a user feels unwillingness on contacting a finger of the user on the scanner due to the use of several persons and the fingerprint is not well recognized when the fingerprint is obscure due to the abrasion of the fingerprint.

Very large scaled banking facilities are using the fingerprint recognition system for the purpose of the authentication of clients in an automatic cash-dispensing machine (ATM). And, offices in charge of welfare in New York and California of America are using the fingerprint recognition system to prevent a double extraction of welfare allowance.

The electronic signature control part 50 controls the fingerprint scanner 30 to scan a fingerprint of a user and create a fingerprint recognition code as a power is applied from the external communication part 20. The electronic signature control part 50 also controls the external communication part 20 to provide the electronic signature service means with the electronic signature creating key when the user's identity is confirmed through the fingerprint recognition part 40 comparing the created recognition fingerprint code with the reference fingerprint code.

The electronic signature service means is preferably a communicative terminal capable of providing a bidirectional communication between the electronic signature service network and the electronic signature service means.

Here, the communicative terminal is defined as a term including a wire communicative terminal and a wireless communicative terminal both capable of performing a voice communication through a public telephone communication network, and a data communication terminal capable of performing a data communication through a data communication network. For example, there are a public telephone network, an integrated service digital network (ISDN), a wireless telephone capable of performing a voice communication through the Internet, etc., for the wire communicative terminal. There are a cellular portable phone, a personal communication service (PCS) phone, a frequency common use phone (TRS phone), an Iridium phone, etc., for the wireless communicative terminal.

Also, there are a pager capable of performing a bidirectional character service, a digital character transmitter/receiver, for example, a two way message (TWM) terminal, a palm-top computer provided with a communication function, a personal digital assistant (PDA) which is a leader of mobile computers.

The powerless electronic signature apparatus based on the fingerprint recognition is focused on a user's convenience.

In case that the USB communication port is adapted for the external communication part, a user should insert the USB communication port into a communication terminal. Simultaneously with the insertion of the USB communication port, a fingerprint of the user is input and the input fingerprint functions as the personal identification number (PIN). To this end, it is unnecessary to input the PIN additively.

Also, since it is general to develop a conventional electronic signature apparatus as a portable type, the conventional electronic signature apparatus is always exposed to a danger of loss. To the contrary, since the electronic signature apparatus of the present invention provides a user with a PIN through a fingerprint recognition which is a kind of a biorecognition way, it has an advantage in that nobody appropriates the PIN except the user. Accordingly, it has a high reliability in confirming the identity of the user and preventing a denial of a stealing.

Moreover, the conventional fingerprint recognition card of a portable type has to be provided with a power within the card. However, the powerless electronic signature apparatus of the present invention receives a power from an external power source on using the same. To this end, it has a permanent life and comparatively low developing cost.

Furthermore, the confirmation of the PIN can be performed within the powerless electronic signature apparatus of the present invention. Therefore, it has very low probability to be subject to the tapping through a communication network or other communication terminals. As described previously, a powerless electronic signature apparatus based on a fingerprint recognition of the present invention stores an electronic signature creating key for an electronic signature and a personal identification number; creates a recognition fingerprint code when a power is applied from the external communication par and provides the electronic signature service means with the electronic signature creating key through the external communication part. As a result, the present is invention can overcome various problems of short life and high developing costs. Further, the present invention provides a superior user convenience. Furthermore, the present invention has a high reliability in confirming the identity of the user and preventing a denial of a stealing.

While specific embodiments of the present invention have been described, various modifications and substitutions will become apparent to one skilled in the art by this disclosure. Such modifications and substitutions are within the scope of the present invention, and are intended to be covered by the appended claims.

What is claimed is:

1. A powerless electronic signature apparatus based on a fingerprint recognition comprises:
a nonvolatile memory for storing an electronic signature creating key for an electronic signature and a personal identification number;
an external communication part having an electrical connection terminal for receiving an external power and a communicative connection terminal for providing an electronic signature service means with the electronic signature creating key;
a fingerprint scanner for scanning a fingerprint of a signer to create a recognition finger code;
a fingerprint recognizing part for comparing the created recognition fingerprint code with a reference fingerprint code and allowing for an access to the electronic signature creating key; and
an electronic signature control part for controlling the fingerprint scanner to create a recognition fingerprint code when a power is applied from the external communication part and controlling the nonvolatile memory to provide the electronic signature service means with the electronic signature creating key through the external communication part.

2. The powerless electronic signature apparatus of claim 1, wherein said external communication part is a USB (Universal Serial Bus) communication port.

3. The powerless electronic signature apparatus of claim 1, wherein the electronic signature service means is selected from a group consisting of a wire communication terminal, a wireless communication terminal, and a data communication terminal all of which provide a bidirectional communication connection for an electronic signature service network.
